(19) United States
(12) Patent Application Publication
(10) Pub. No.: US 2009/0205384 A1
(43) Pub. Date: Aug. 20, 2009

(54) ELECTROMECHANICAL LOCKING SYSTEM

(75) Inventor: ITZHAK POMERANTZ, Kfar Saba (IL)

Correspondence Address: MARK M. FRIEDMAN, C/O DISCOVEY DISPATCH , 9003 FLIRIN WAY, UPPER MARLBORO, MD, 20772, US

(73) Assignee: SanDisk IL Ltd., Kfar Saba (IL)

(21) Appl. No.: 12/032,713

(22) Filed: Feb. 18, 2008

(51) Int. Cl. E05B 47/02; E05B 49/00

(52) U.S. Cl. 70/278.3

(57) ABSTRACT

An electromechanical locking system includes a locking mechanism that is switchable between a locked position and an unlocked position, a keyway for receiving a rotatable key, a latch, and an angle detector for detecting an angular orientation of the key while the key is in the keyway. After detecting a sequence of angular orientations of a key, the angle detector may issue a corresponding angle sequence data. A lock controller controls the latch in accordance with an authentication data that has been received from the key and the issued angle sequence data that reflects a combination code. If the authentication data and the angle sequence data are both valid, the lock controller enable operation of the latch, whether automatically or manually. The key includes a light source that projects a light beam at an acute angle in order to provide a visual indication of a current angular orientation of the key.

### FIELD OF THE INVENTION

The present invention generally relates to electronic combination locks, and more specifically to a combination lock system in which the combination code is entered by using a rotatable key.

### BACKGROUND

Lock devices have been used for many years to lock different things. The simplest lock devices are all-mechanical and codeless, and they provide the simple functionality of selecting between “lock” state and “unlock” state without using any “user code” or “lock code”. Electro-mechanical lock devices are another type of lock devices. Some electro-mechanical lock devices are operated by using a secret code that is known only to a certain group of people, and sometimes only to the key owner. A code that must be entered by a user to operate a lock device is referred to as “something you know”, whereas the key is referred to as “something you have”.

In other sophisticated locking mechanisms, the key is an electronic key that exchanges authentication information with the lock device and upon engaging an electronic key with a lock device, such as by attaching the key to, or waving it in front of, the lock device, the lock device inquires the key about its authentication information, which may be, for example, the identification details or serial number of the key. The process by which one device (e.g., the lock device) inquires another device (e.g., the key) for its identity is known as “challenge and response authentication”. In computer security challenge-response authentication is a family of protocols in which one party, for example a lock device, poses a question (“challenge”) and another party, for example a key of a lock device, must provide a valid answer (“response”) to be authenticated. The simplest example of a challenge-response protocol is password authentication, where the challenge is asking a device for a password and the valid response is the correct password. The key user can operate the lock device (i.e., lock or unlock the lock device) only after the key has been authenticated by the lock device. To render to lock systems a higher level of security, in addition to the use of authentication information, the user must use a correct code or some biometric data to operate the lock device; i.e., provided that the authentication process has been concluded successfully.

Electronic combination locks use a combination code that is uniquely associated with a particular lock. A combination code is a mathematical combination of numbers or values that, if entered in the correct order, unlock the involved lock the lock device. To open such a lock, a person has to use a unique combination code that is checked by a lock controller. Electronic combination locks, and other types of conventional lock systems, include a keypad for entering codes. However, using a keypad is problematic because a secret code might be visually intercepted by an unauthorized person while the code is entered by an authorized person. Keypads must be kept exposed to authorized persons, but, at the same time, they are exposed to sabotage. Further, keypads need to be installed on, near, or at, the vicinity of the lock system or protected space or facility, and wired to some kind of a control console. In addition, keypads are bulgy, and therefore unaesthetic. In some prior art locking systems the device (usually an electronic key) that communicates authentication information to the lock system and the device that actually operates the lock system are separate, un-interlocked, devices. In other prior art lock systems the keys are self-powered; i.e., they include an electric battery, which is problematic because a self-powered key will not work if the energy of its battery has decreased below some level. It will, therefore, be beneficial to have a lock system where a single, battery-free, key authenticates itself to the lock system and is used to enter a combination code and, if desired, also for operating a latch of the lock system.

### SUMMARY

The following embodiments and aspects thereof are described and illustrated in conjunction with systems, tools, and methods, which are meant to be exemplary and illustrative but not limiting in scope.

As part of the present disclosure an electromechanical locking system is provided, which includes a locking mechanism that is switchable between a locked position and an unlocked position, a keyway for receiving a rotatable key, and a latch mechanism or arrangement for locking an object such as a door of a room or safe. The electromechanical locking system also includes an angle detector. The angle detector is operative to detect an angular orientation or position of the rotatable key while the key is in the keyway, and, after detecting a sequence of angular orientations of a key, the angle detector may issue a corresponding angle sequence data. The electromechanical locking system also includes a lock controller for controlling the latch in accordance with an authentication data that has been received from the key, and an angle sequence data that has been issued by the angle detector.

Responsive to the lock controller ascertaining the validity of both the authentication data and angle sequence data, the lock controller may enable operation of the latch. According to some embodiments while the lock controller is in enabling state the latch is operable electromechanically by the lock controller. According to other embodiments the latch is operable manually, by the key operator.

According to some embodiments the key includes a memory device for holding authentication data that pertains to one or more of the keys, to a user of the key, and to the electromechanical locking system; a communication interface for communicating the authentication data to the lock controller; and optionally a light source that is operative to project a light beam in order to provide a visual indication of a current angular orientation of the key. The light source, which may be a laser diode, may be positioned in such a way that it projects a light beam in the general direction of the lock system, at an acute angle (relative to a distal end of the key).

A method of operating an electromechanical locking system is also provided. The method includes issuing, by the angle detector, angle sequence data associated with a sequence of angular orientations of a key mechanically coupled to the locking mechanism. The key contains authentication data and enables, by the lock controller, operation of a latch of the locking mechanism if the authentication data is found by the lock controller to be valid and the sequence of angular orientations matches a predetermined sequence of angular positions of the key.

In addition to the exemplary aspects and embodiments described above, further aspects and embodiments will become apparent by reference to the figures and by study of the following detailed description.

### BRIEF DESCRIPTION OF THE DRAWINGS

Exemplary embodiments are illustrated in referenced figures. It is intended that the embodiments disclosed herein are illustrative rather than restrictive. The disclosure, however, may better be understood with reference to the following detailed description when read with the accompanying figures, in which:

FIG. 1 shows an external view of a lock system according to an example embodiment of the present disclosure;

FIG. 2 shows the lock system of FIG. 1 and a rotatable key in a first exemplary angular orientation;

FIG. 3 shows the lock system of FIG. 2 and the rotatable key in a second exemplary angular orientation;

FIG. 4 schematically illustrates the lock system of FIGS. 1 through 3;

FIG. 5A schematically illustrates the electronic portion of a key according to an example embodiment of the present disclosure;

FIG. 5B schematically illustrates the key of FIG. 5A projecting a light beam to visualize the angular orientation of the key;

FIG. 5C schematically illustrates different light projection angles of the key of FIG. 5B;

FIG. 6 shows a method for operating a lock system according to an example embodiment of the present disclosure;

FIG. 7 shows a method for operating a lock system according to another example embodiment of the present disclosure;

FIG. 8 shows a key according to another example embodiment of the present disclosure;

FIG. 9A shows an external view of a cylinder lock (shown at 900) according to an example embodiment of the present disclosure;

FIGS. 9B shows the rotor of FIG. 9A in more details according to an example embodiment of the present disclosure;

FIG. 9C shows the key of FIG. 8 engaged with the lock of FIG. 9A;

FIGS. 10A, 10B, 10C, and 10D, show a key with a user angle indicator according to one example embodiment of the present disclosure; and

FIGS. 11A, 11B, 11C, and 11D, show a key with a user angle indicator according to another example embodiment of the present disclosure.

It will be appreciated that for simplicity and clarity of illustration, elements shown in the figures are not necessarily drawn to scale. Further, where considered appropriate, reference numerals may be repeated among the figures to indicate like, corresponding or analogous elements.

### DETAILED DESCRIPTION

The claims below will be better understood by referring to the present detailed description of example embodiments of the invention. This description is not intended to limit the scope of claims but instead to provide examples of the invention.

People are used to plug a key into a keyway of a locking system and revolve it clockwise (“CW”) and counterclockwise (“CCW”) to lock and unlock their home, car, and so on. According to the present disclosure a key for a locking system includes an authentication data (“something you have”) that, when engaged with the locking system, authenticates the key to the locking system. According to the present disclosure the same key is also used to enter a combination code (“something you know”). The locking system will be operable only if the authentication data and the combination code are both valid. The way a key is used to enter a combination code is described below.

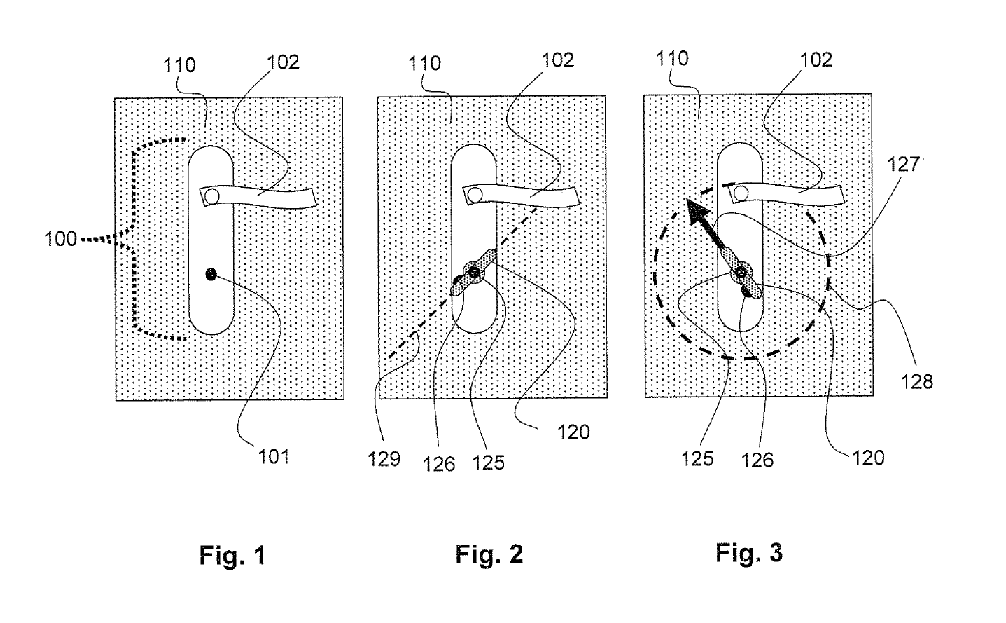

FIG. 1 shows an external view of a key operated lock (generally shown at 100) that is installed in a door (shown at 110) according to an example embodiment of the present disclosure. Lock 100 includes a keyway 101, through which a key of the present disclosure can be inserted, a door handle 102 by which the door 110 may be opened, closed, locked, and unlocked, a locking mechanism and an electromechanical control system (both are not shown in FIG. 1). In a conventional door the open/close bolt or tab actuated by a door handle and the lock/unlock locking bolt or tab actuated by a key are separate and independent bolts or tabs and are in un-interlocked relationship. This means that, in a conventional lock environment, door handle 102 would have actuated a bolt or a tab only for opening and closing door 110, and a key that would have been inserted into keyway 101 would have actuated another bolt or tab only for locking and unlocking door 110, and these two bolts or tabs would have been in un-interlocked components.

However, according to one example embodiment of the present disclosure the open/close bolt or tab actuated by door handle 102 and the lock/unlock bolt or tab door actuated by a key in door handle 102 are interlocked, as described below In other example embodiments these two functions (locking/unlocking and opening/closing) are executed by the same bolt or tab; i.e., the same locking bolt or tab can be used for locking and unlocking the door, and for opening the door (i.e., after the bolt or tab is unlocked). It is noted that the locking mechanism and the electromechanical control system (both are not shown in FIG. 1) of the present disclosure can be installed or integrated into other types of doors and into other objects.

FIG. 2 shows lock 100 of FIG. 1 with a key 120 inserted into keyway 101. Key 120, which is a rotatable key, is shown in an exemplary angular orientation 129 that can uniquely reflect, represent, designate, or can otherwise be associated with, a certain data item which, typically, is a number in a sequence of numbers that constitute a combination code that is required to unlock door 110. The terms “key's position” and “key's angular position”, as used herein, refer to an angular position, or angular orientation, of a key. As explained above, combination codes for operating lock systems are conventionally entered electronically, by using a keypad, or mechanically, by using a combination disc assembly. According to the present disclosure the combination code is entered using key 120.

Although key 120 includes electronic components for holding data such as, but not limited to, authentication data, and for communicating with the lock system 100, key 120 is not an electronic card per se; i.e., key 120 electronically holds authentication data but, unlike electronic cards which are used to unlock doors (for example), key 120 has another function, which is entering the combination code by being rotated inside keyway 101 several times to create a combination code that, if entered in the correct sequence, will enable operation of the lock system 100. In some embodiments key 120 is always rotated in the same direction (e.g., CW). In such embodiments, upon reaching a prescribed angular position the key is held, or left stationary, in this position long enough (e.g., between 0.5 second and 1 second) for the lock system to be able to record the key's current position. Alternatively, a depressible button on key 120 (shown at 125) may be depressed by the key operator to signal the lock system that the key's current angular position should be recorded for future check out, or checked out first and recorded if it is a valid key's position whose relative location within the combination code is correct. Then, key 120 can be rotated in the same direction to the next angular position and depressible button 125 can be depressed again, and so on. Reference numeral 126 designates an alternative depressible button for signaling key's positions to the lock system. A depressible button that functions in the way described above is hereinafter referred to as an “angle signaling button”. Although not shown in the drawings, in an alternative embodiment, the lock system 100 of FIG. 1 includes an angle signaling button that, when momentarily actuated by the key (for example by being pushed by the key in the key's axial direction), signals the lock system that the lock system should read and check a current angular position of the key. Installing the angle signaling button in the lock system rather than in the key reduces the mechanical complexity of the key.

In other embodiments key 120 is rotated in a given direction to a predetermined angular position and then it is rotated in the opposite direction until key 120 reaches the next predetermined angular position, and so on. In these embodiments the key can be held in a current angular position long enough for the lock system to be able to record the key's position, or, alternatively, the angular position that is recorded is the last angular position that was measured before the rotation direction changed.

To enter a combination code, a user inserts key 120 into keyway 101 and rotates key 120 inside keyway 101 in a first direction (e.g., CW) until key 120 is brought to an angular orientation which corresponds to a first position in a predetermined sequence of angular positions that is derived from, or corresponds to, a combination code (e.g., 11→7→12→3). FIG. 2 shows key 120 in an exemplary first angular position in keyway 101. The 360-degree revolution of key 120 may be associated with a parameter and the angular resolution may be determined accordingly. The parameter may be associated, for example, with time, which may be, for example, the time of day, the date of year, etc. For example, the 360-degree revolution of key 120 may be associated with the location of the hour hand of a clock and accordingly be divided into 12 (or 24) distinct, evenly spaced, angular positions, sections, “steps”, or areas. That is, a number in a combination code may be an hour of a day, for example 3:00. The 360-degree revolution may be aligned with the selected parameter (e.g., the time) as desired. For example, zero degrees may be equivalent, or correspond, to 12:00. Likewise, 30 degrees may be equivalent, or correspond, to 13:00, 60 degrees to time 15:00, and so on.

To continue the combination code, the user rotates key 120 inside keyway 101 until key 120 is brought to an angular orientation which is a second position in the predetermined sequence of angular positions. As explained above, the user may rotate key 120 to the next angular orientation by rotating key 120 either in the same direction or in the opposite direction, depending on the embodiment.

FIG. 3 shows key 120 in an exemplary second angular position in keyway 101. A light source, which is embedded in key 120, projects a light beam 127 towards door 110 to visually indicate to the key operator the angular orientation of key 120. Reference numeral 128 designates a collection of light-door intersection points (shown as a dashed-line circle), where each light-door intersection point designates a unique angular orientation of key 120. If the combination code consists of, say 4 numbers (e.g., 5-12-4-9), the key operator has to rotate key 120 to four angular positions, each angular position associated with a respective number. Therefore, rotations of key 120 create a sequence of angular positions of key 120 that, if matches a predetermined sequence of angular orientations, enables the operation of a latch mechanism inside lock system 100.

As long as the correct sequence of angular positions of key 120 has not been detected by lock system 100, key 120 may be allowed to rotate 360 degrees inside keyway 101, or its rotation may be mechanically restricted to a narrower angle (e.g., 135 degrees), without changing the locking status of lock system 100 from the “locked” state to the “unlocked” (or vice versa). However, after rotating key 120 “through” the predetermined sequence of angular positions, the rotation of key 120 may be restricted to an angle that is required to lock or unlock door 110. In other words, lock system 100 may include a clutch mechanism (not shown in FIGS. 1 through 3) that is released while lock system 100 is waiting to receive a correct sequence of angular positions of key 120, and activated for a predetermined period of time after receiving the correct sequence of angular positions When activated, the clutch mechanism may couple key 120, such as by using friction discs or a clutching bolt, to a locking mechanism of lock system 100 to allow the key operator only to open door 110, or only to lock door 110, or to both open and close door 110.

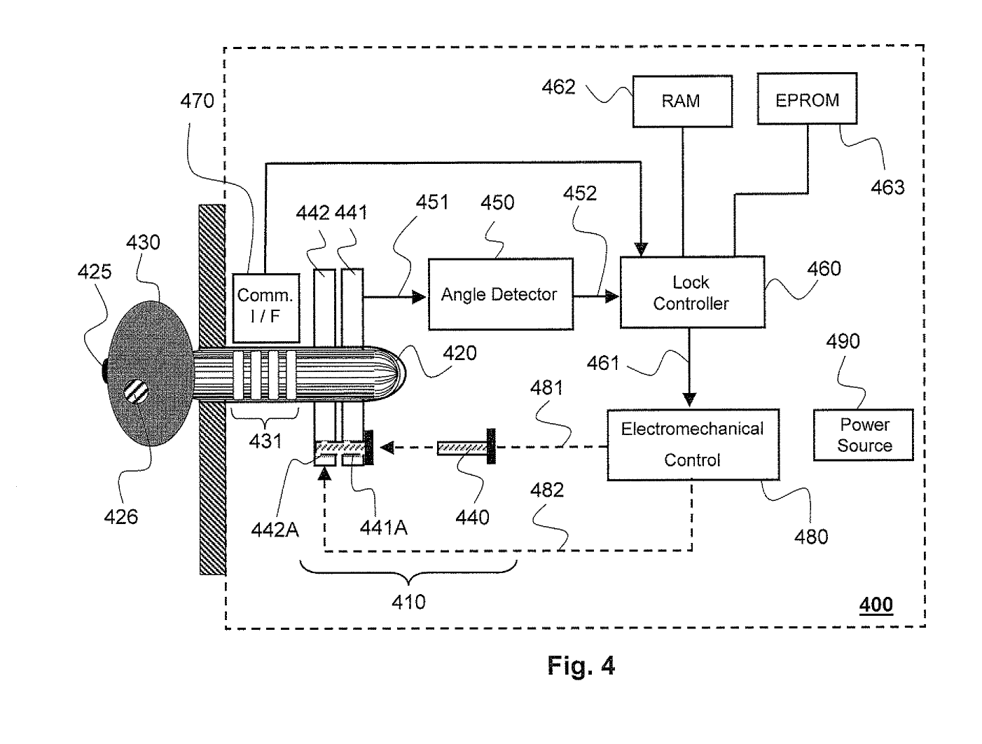

FIG. 4 illustrates an electromechanical locking system 400 according to one example embodiment of the present disclosure. Electromechanical locking system 400 includes a locking mechanism (generally shown at 410) that is switchable between a locked position and an unlocked position. Other types of lock assemblies may be used instead of the locking mechanism shown in FIG. 4. Locking mechanism 410 includes a keyway 420 for receiving a key such as key 430, and a latch that, in the example embodiment of FIG. 4, includes latch pin 440 and latch disc 442. Latch disc 442 may be designed to actuate a locking member or a deadbolt (not shown in FIG. 4), for example a bolt or a tab, that locks an object such as door 110 of FIG. 1. In other words, an object housing a locking system such as locking system 400 can be locked and unlocked by allowing latch disc 442 to move the locking member to a desired position (i.e., “locked” or “unlocked”).

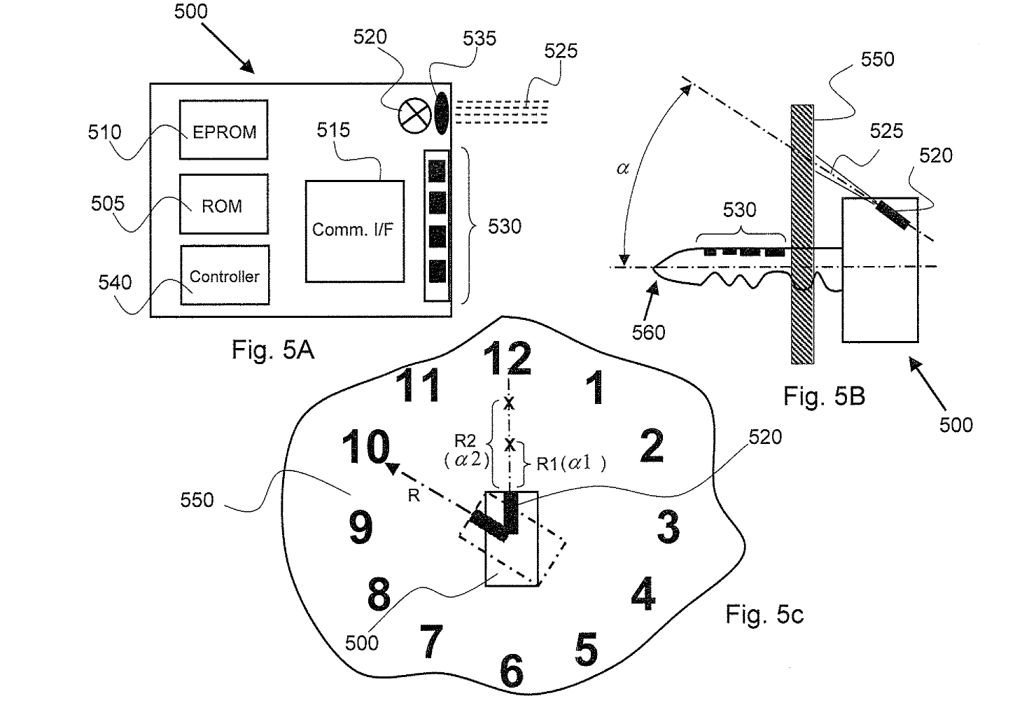

Lock system 400 also includes an angle detector 450 that detects a sequence of angular orientations, on of key 430 in keyway 420. Angle signaling button 425 (or alternative angle signaling button 426) may be depressed by the key operator to signal the lock system that the key's current angular position should be read for check out. Angle detector 450 issues an angle sequence data that corresponds to, represents or reflects the sequence of angular orientations of key 430 as detected by angle detector 450. An angular position of key 430 may be associated with a unique parameter which may be, for example, a function of time, as demonstrated in FIG. 5C.

Lock system 400 also includes a lock controller 460. Lock controller 460 is provided with random access memory (“RAM”) 462 for making calculations, and with erasable programmable read only memory (“EPROM”) 463 for storing the locking application, various parameters, one or more pre-stored combination codes, and one or more sequence of angular positions of keys that result from previous and current attempts to operate the locking mechanism 410.

When inserted into keyway 420, key 430 communicates with communication interface 470. During communication with communication interface 470 key 430 transmits, or otherwise transfers, authentication data to communication interface 470. Lock controller 460 is functionally connected to communication interface 470 and receives therefrom the authentication data of key 430. Lock controller 460 controls (shown as dashed line 481) latch pin 440, via electromechanical control 480, in accordance with the authentication data received from key 430, and in accordance with an angle sequence data issued by angle detector 450. Lock controller 460 checks the validity of the authentication data and angle sequence data, and if lock controller 460 determines that they are both valid, lock controller 460 enable operation of the locking mechanism 410, automatically or manually. Checking the validity of the authentication data and angle sequence data generally involves comparison of the authentication data to pre-stored authentication data, and the angle sequence data to pre-stored angle sequence data. The pre-stored authentication data and pre-stored angle sequence data may be pre-stored, for example, in EPROM 463. Electromechanical control 480 may be a solenoid, for example, that pulls and pushes latch pin 440 according to control signal or control data that lock controller 460 forwards (shown at 461) to electromechanical control 480. Lock system 400 also includes power source 490 for powering the lock system's electrical components, and also for powering key 430 when key 430 resides within the keyway.

Locking mechanism 410 also includes a clutch disc 441 that is conditionally rotatable by key 430. Clutch disc 441 can, therefore, be used as an angular position sensor from which angle detector 450 receives (shown at 451) raw angle data or raw angle signal as key 430 is rotated in keyway 420 by the key operator. Based on the raw angle data, or raw angle signal, angle detector 450 generates or issues an angle sequence data that is forwarded (shown at 452) to lock controller 460. Lock controller 460 compares the angle sequence data to reference angle sequence data that is stored in EPROM 463, for example, in order to determine whether the angle sequence data, and therefore the entered combination code, are valid. Angle detector 450 may detect the angular orientation of clutch disc optically or mechanically, for example by using a shaft encoder.

Latch disc 442 and clutch disc 441 are shown in FIG. 4 in un-interlocked state, which means that key 430 can rotate clutch disc 441 but not latch disc 442. This means that, whatever the current state of the lock system (i.e., “locked” or “unlocked”), it cannot be changed by key 430 unless key 430 is rotated “through” a sequence of angular positions that is determined by controller 460 as valid. If a sequence of angular positions engages is determined by lock controller 460 to be valid, lock controller 460 forwards (shown at 461) an “interlock” control signal to electromechanical control 480 which, in return, pushes (extends) latch pin 440 through openings 441A and 442A, respectively, in the clutch disk 441 and the latch disk 442, to thereby clutch, engage, or interlock clutch disc 441 and latch disc 442. While clutch disc 441 and latch disc 442 are interlocked by latch pin 440, key 430 can unlock the lock system by rotating clutch disc 441, and thus latch 442 which, in return, can actuate the locking member (not shown in FIG. 4) to unlock the lock system.

More generally, responsive to lock controller 460 ascertaining the validity of both the key's authentication data and the angle sequence data, lock controller 460 enables operation of the latch disc 442. By “lock controller 460 enables operation of latch disc 442” is meant that lock controller 460 can be configured to enable manual operation of latch disc 442, such as by a person rotating key 430 or using a door handle, or automatic operation of latch disc 442. In the manual mode of operation lock controller 460 causes electromechanical control 480 to push (shown at 481) latch pin 440 into openings 441A and 442A of clutch disc 441 and latch disc 442, respectively, to engage the two discs 441 and 442. While engaged, angular orientations of clutch disc 441, which are caused by the key 430 rotating in the keyway, are transferred to latch disc 442 which, in return, actuate the locking member (not shown in FIG. 4) to effect the desired lock operation (i.e., locking or unlocking). In the automatic mode of operation lock controller 460 causes electromechanical control 480 to actuate the locking member directly, or indirectly by operating (shown at 482) latch disc 442. Key 430 may be mechanically coupled to the latch directly or via a shaft or spindle.

Keyway 420 is provided with electric power and communication contacts (not shown in FIG. 4) for powering key 430 and to facilitate communication between key 430 and communication interface 470 whenever key 430 resides within keyway 420. Methods for providing power and for enabling communication between a rotating object, such as key 430, and a non-rotating object, such as the locking mechanism 410, are known to those having skill in the art. For example, slip rings, or rotating connectors, may be used, as demonstrated in FIG. 4, where key 430 and communication interface 470 communicate through use of slip rings 431 which are ring-like electric terminals. Although not shown in FIG. 4, keyway 420 includes counter slip rings that are in contact with slip rings 431 as long as key 430 resides within the keyway. By using slip rings, communication between key 430 and communication interface 470 is maintained regardless of the angular orientation, or rotational movement, of key 430 within keyway 420.

In electrical engineering a slip ring is a method of making an electrical connection through a rotating assembly. Slip rings are commonly found, for example in packaging machinery, cable reels, and wind turbines. Briefly, a slip ring consists of a conductive band mounted on a shaft and insulated from it. Electrical connections from the rotating part of the assembly are made to the stationary slip ring. Electrical power and various signals can be exchanged, via the slip rings, between the rotating part of the assembly and the stationary part of the assembly. Rotating connectors are commercially available, for example from Mercotac, Inc., Kevlin Corp., and Sibley Company.

Key 430 may be identical or similar to electronic keys that are manufactured, for example by Datakey Electronics. Angle detector 450 may detect the angular orientation of key 430 within keyway 420 by using a shaft encoder that is manufactured, for example by RINGDALE Inc. Key 430 may alternatively include a smart USB rotation sensor of the kind manufactured, for example by Toradex AG.

Lock system 400 may further include a timer (not shown in FIG. 4) for limiting the time window during which a key operator is allowed to enter the correct combination code. The timer may be reset by the key 430 insertion into keyway 420, and than it may freely run while the key operator tries to enter the correct combination code. If the key operator does not enter the correct combination code during a prescribed time (e.g., 30 seconds), depending on the involved security policy lock controller 460 may permanently or temporarily disqualify or invalidate the key.

FIG. 5A shows the electronic components of a key (shown at 500) according to one example embodiment of the present disclosure. Key 500 includes a first memory device 505 for holding an application that is required for electronic operation of key 500, and a second memory device 510 for holding authentication data and possibly other types of information. First memory device 505 and second memory device 510 may each be a flash memory device or other type of non-volatile memory device. A flash memory device may be a WORM (“Write-Once-Read-Many”) memory device. The authentication data may pertain to the key, to the owner or legitimate user of the key, or to the electromechanical locking system. Data pertaining to the key may include an identification data (ID) of the key or the key's serial number.

Key 500 also includes a bidirectional data communication interface 515 for communicating the authentication data, and optionally additional information, to a lock controller such as the lock controller 460 of FIG. 4. Key 500 may also include a light source such as light source 520 for projecting a light beam in order to provide, to an operator of the key, a visual indication of a current angular orientation of the key within the keyway. Key 500 may also include a collimating lens such as lens 535. Light source 520, which may be a laser diode, is positioned in the key 500 in such a way that it projects a light beam 525 at an acute angle (not shown in FIG. 5) relative to a distal end of the key, towards the lock.

Key 500 also includes a power and data communication electrical connector 530 that can be connected to a power source such as power source 490 of FIG. 4, for powering key 500, and to a bidirectional communication interface such as bidirectional communication interface 470, to facilitate bidirectional communication between the key controller 540 and a lock controller such as lock controller 460. If the involved key is cylindrical, the electrical terminals of the power and data communication connector may be implemented as slip rings. If the involved key is flat, the electric terminals of the power and data communication connector may be flat. A key data communication interface 515 may also be used for receiving from a host device (not shown in FIG. 5A) the key's authentication data and other required data, in order for them to be pre-stored in EPROM 510. Some data, though, may be held in ROM 505.

Data communication interface 515 may conform to the universal serial bus (“USB”) protocol. Controller 540 and the lock controller with which controller 540 cooperates may use handshaking process, and the lock controller may use a “challenge and response authentication” protocol to obtain the key's authentication data. In telecommunications and related fields “handshaking” is an automated process of negotiation that dynamically sets parameters of a communication channel that is established between two devices before normal communication there between begins. Handshaking follows the physical establishment of the channel and precedes normal information transfer. Electrical contacts 530 and data communication interface 515 facilitate storage of authentication data, and other types of data or information, in key 500, for example in EPROM 510.

FIG. 5B shows light beam 525 projected onto the external surface 550 of a door from light source 520 of key 500 at an acute angle α relative to the distal end 560 of key 500. A spotlight on surface 550 visually indicates the angular orientation of the key to an operator of the key. The greater α, the farther the spotlight encounters the external surface 550 of the door, and the better the circumferential resolution. Electrical contacts 530 are connected to corresponding electrical contacts in the lock system (not shown in FIG. 5B), for example via slip rings.

FIG. SC shows two exemplary light source angles in accordance with the present disclosure. By way of example, the area around key 500 is evenly divided into 12 sections to mimic the 12 hours of a clock (shown as “1”, “2”, . . .,“12”). Key 500 is shown in FIG. 5C in a first angular orientation in which light source 520 projects a light beam in the direction that represents the hour 12, and in a second angular orientation (shown in dashed line) in which light source 520 projects a light beam in the direction that represents the hour 10. The distance R, at which the light beam encounters surface 500, depends on the light projection angle α, and, as already mentioned above, the greater α, the farther the spotlight encounters the external surface 550 of the door. For example, at a light projection angle α1 the light encounter distance is R1, whereas at a light projection angle α2 (where α2>α1) the light encounter distance is R2 (where R2>R1).

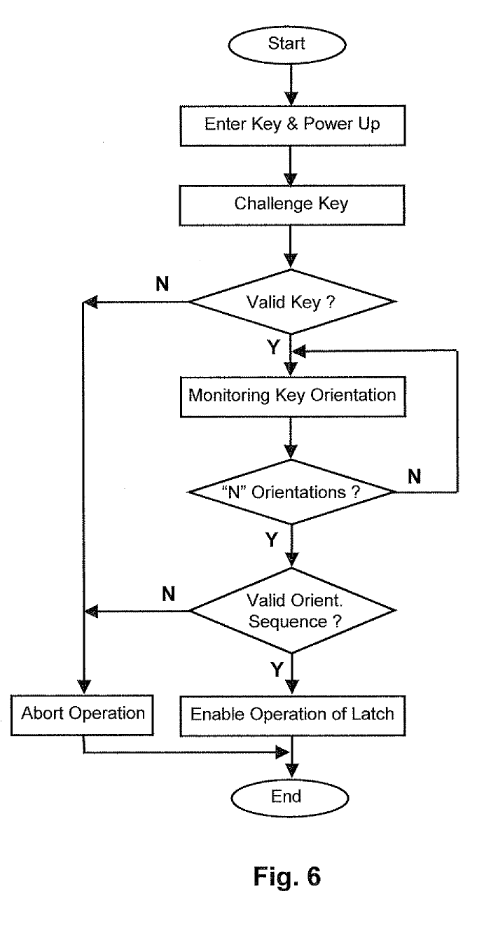

FIG. 6 shows a method for operating an electromechanical locking system according to one example embodiment of the present disclosure. FIG. 6 will be described in association with FIG. 4. At step 601, key 430 which holds authentication data, is inserted into the keyway or cylinder of the locking mechanism 410 and powered by power source 490, and a communication link is established between the key's controller and lock controller 460. At step 602, lock controller 460 challenges the validity of key 430, for example, by using a challenge and response authentication protocol. During the challenge and response process, key 430 communicates the authentication data to controller 460, via communication interface 470. At step 603, lock controller 460 checks the validity of the key's authentication data. If the lock controller 460 determines that the key's authentication data does not match a pre-stored authentication data or it is invalid (shown as “N” at step 603), the unlocking procedure will be aborted (shown at 604) and key 430 will not be able to transition locking mechanism 410 into its “unlock” state. Otherwise (the key's authentication data is determined as valid, shown as “Y” at step 603), angle detector 450 starts monitoring, at step 605, the angular orientation of key 430. By “monitoring” is meant detecting, by angle detector 450, the current key's angular position, or orientation, and recording it by lock controller 460 in EPROM 463, for example.

Since a combination lock consists of N numbers, where N can typically equal 3 or 4, it is checked, at step 606, whether a sequence of N key's positions was detected and recorded. If less than N key's positions were recorded (shown as “N” at step 606), the lock system continues (shown at 616) to monitor the key's orientation. Otherwise (a sequence of N key's positions has already been recorded, shown as “Y” at step 606), it is checked by lock controller 460, at step 607, whether the recorded sequence of N key's positions matches a pre-stored or predetermined sequence of angular orientations. If the newly recorded sequence of key's positions differs from the pre-stored or predetermined sequence of angular orientations (shown as “N” at step 607), the unlocking procedure will be aborted (shown at 604) and key 430 will not be able to transition locking mechanism 410 into the “unlock” state. Otherwise (the two sequences match, shown as “Y” at step 607), the key is authorized to unlock locking mechanism 410, or lock controller 460 may unlock the lock system automatically; that is, if it configured to do so. Alternative methods for unlocking locking mechanism 410 by key 430 and by lock controller 460 are described above.

Instead of recording the entire sequence of key's positions and only then checking the validity of the entire sequence, in an alternative way each key's position is checked first for its validity and the unlocking procedure aborts after detecting the first invalid key position, or after some temporal delay, or after n unsuccessful attempts to enter a correct key position.

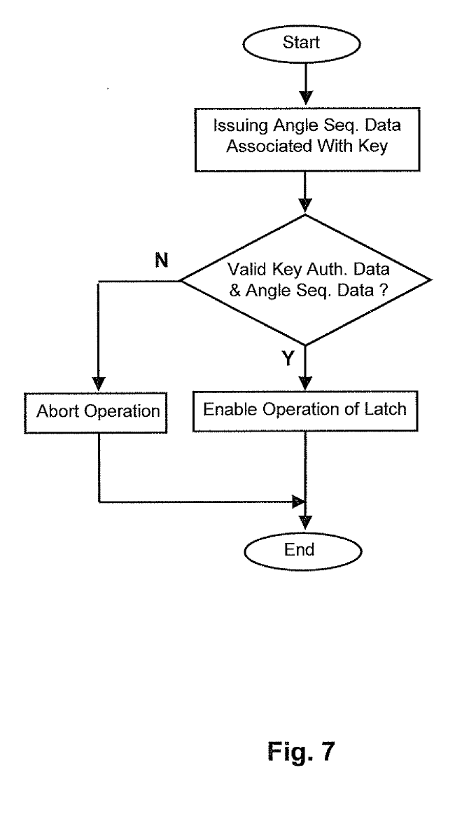

FIG. 7 shows a method for operating an electromechanical locking system according to another example embodiment of the present disclosure. FIG. 7 will be described in association with FIG. 4. After key 430, which holds authentication data, is inserted into the keyway or cylinder of the locking mechanism 410, key 430 is powered by power source 490 and a communication link is established between the key's controller and lock controller 460. Then, lock controller 460 challenges the validity of key 430, for example, by using a challenge and response authentication protocol. During the challenge and response process, key 430 communicates the authentication data to controller 460, via communication interface 470.

At step 701, angle detector 450 issues angle sequence data that is associated with a sequence of angular orientations of key 430 that is mechanically coupled to the locking mechanism 410. At step 702, it is checked by lock controller 460 whether the key's authentication data is valid and the sequence of key's angular orientations matches a pre-stored or predefined sequence of angular positions of the key. If the key's authentication data is valid and the sequence of key's angular orientations matches the pre-stored or predefined sequence of angular positions of the key (shown as “Y” at step 702), lock controller 460 enables operation of the latch of locking mechanism 410. Otherwise (if at least one of the above described conditions is not met, shown as “N” at step 702), the lock system operation process is aborted at step 704. While the lock controller 460 is in enabling state, the latch mechanism may be operable electromechanically by lock controller 460, or manually, in which mode the operator of key 430 can rotate key 430 to thereby cause latch disc 442 to operate the lock member (e.g., a locking bolt or tab).

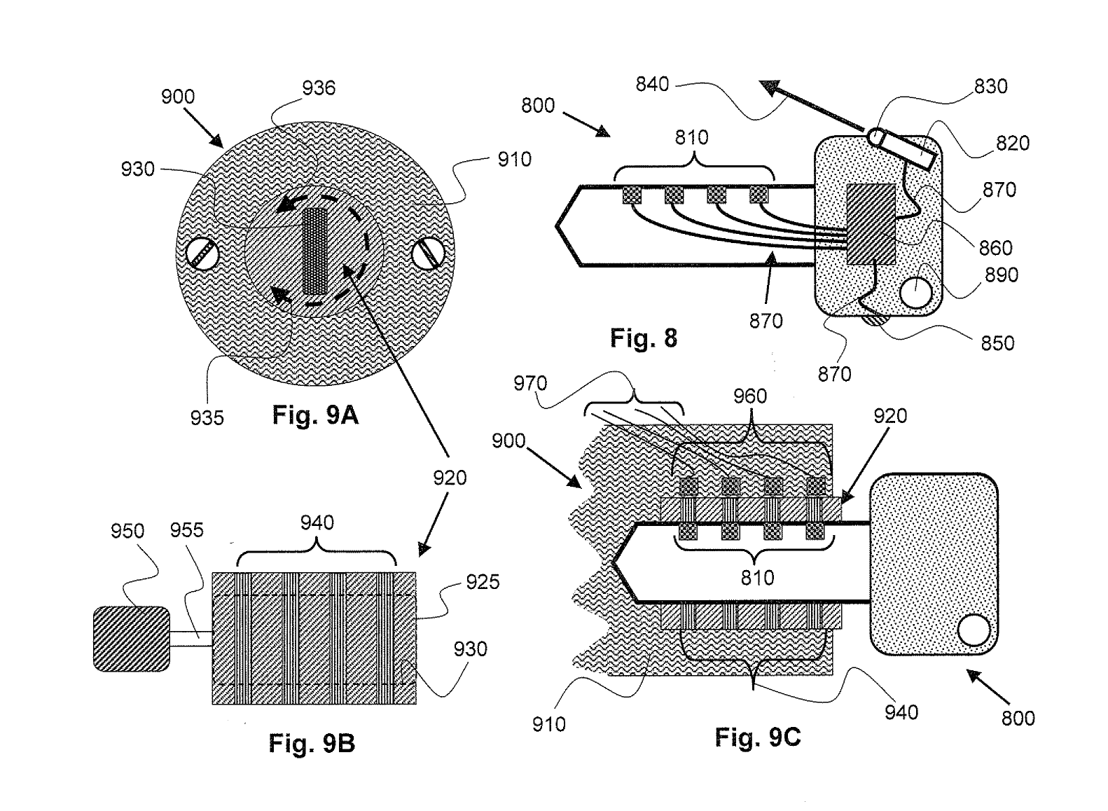

FIG. 8 shows a key (shown at 800) according to another example embodiment of the present disclosure. Key 800, which in this example embodiment is generally flat, includes example electric terminals 810 via which key 800 can electrically be powered, and via which key 800 can communicate with a lock controller such as lock controller 460 of FIG. 4. A key similar to key 800 may be provided or equipped with less electric terminals or more electric terminals. In addition, the shape of an electrical terminal may differ from the shape of electric contacts 810. The number of electric terminals generally depends on the type of electric signal that needs to be fed to key 800, and on the involved data communication protocol. Four electric terminals, as demonstrated in FIG. 8, may conform to, or it may comply with, the universal serial bus (USB) communication protocol.

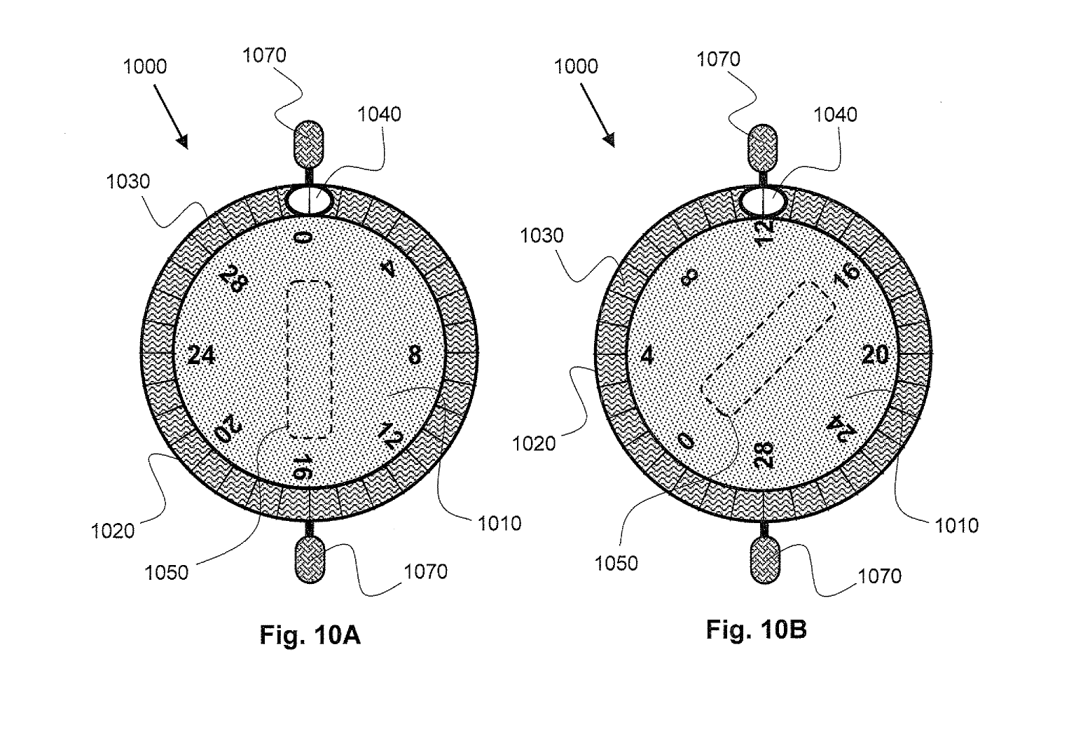

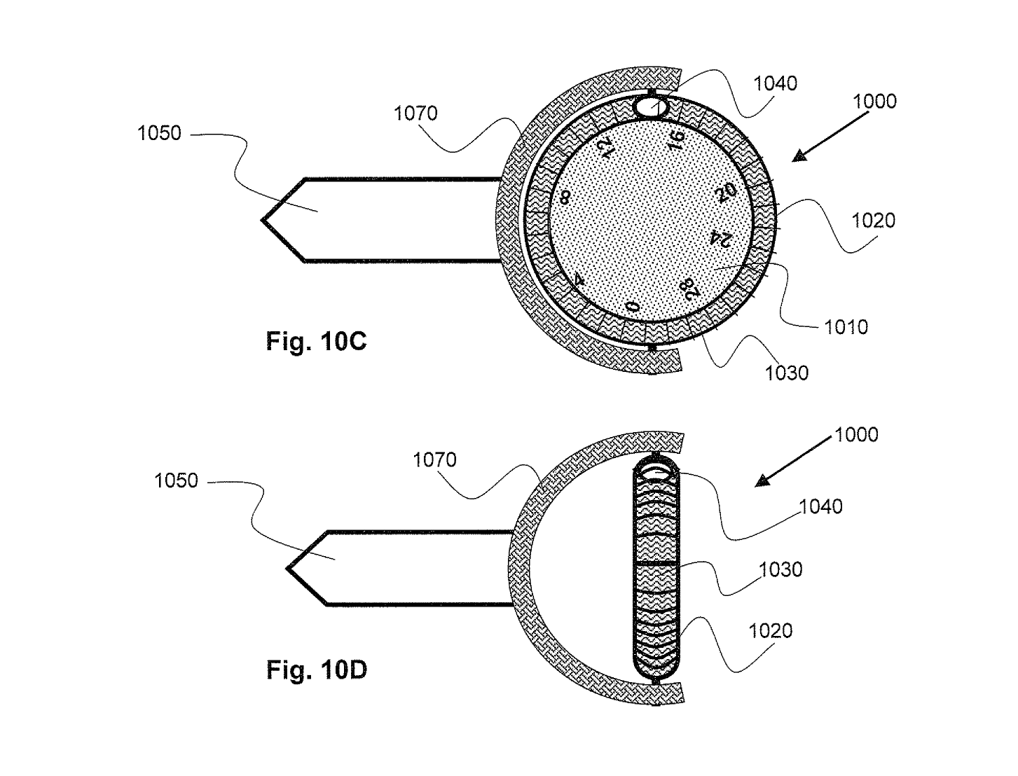

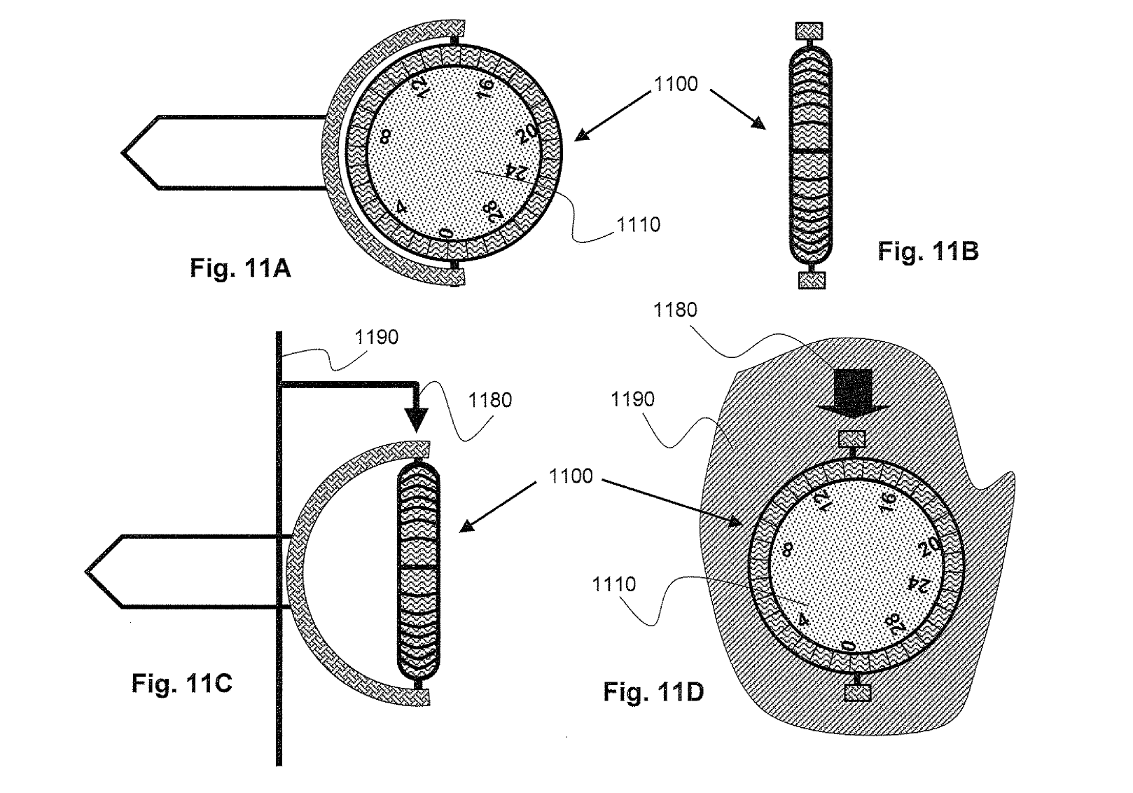

Key 800 also includes a light source 820, an optional collimating lens 830, and an angle signaling button 850. Light source 820 projects light 840 in acute angle relative to the distal end of key 800, and it generally functions in the same manner as source light 520 of FIG. 5B. Key 800 also includes an electronic chip 860. Electronic chip 860 may include a memory device similar or identical to ROM 505 or to EPROM 510, a key controller, and a data communication interface. Electronic chip 860 is electrically wired, by wires 870, to electric terminals 810, light source 820, and to angle signaling button 850. Opening 890 allows attaching key 800 to a key ring. Light source 820 is only an exemplary user angle indicator. Other user angle indicators may be used, as shown in, and described below in connection with, FIGS. 10A through 10D and FIGS. 11A through 11D.

FIG. 9A shows an external view of a cylinder lock (shown at 900) according to an example embodiment of the present disclosure. Lock 900 includes a stationary body 910 (referred to herein as “stator”) and a rotatable cylinder 920 (referred to herein as “rotor”). Rotor 920 includes a generally rectangular keyway 930 for accommodating a key such as key 800 of FIG. 8. Rotor 920 is rotatable relative to stator 910 by inserting key 800 into keyway 930 and rotating key 800 to the required direction (i.e., CW, shown at 935, or CCW, shown at 936).

FIG. 9B shows rotor 920 of FIG. 9A in more details according to an example embodiment of the present disclosure. Rotor 920 includes four slip rings 940 that respectively engage electric terminals 810 while key 800 resides within rotor 920. Rotor 920 is mechanically coupled by shaft or spindle 955 to an angular position sensor 950 which functions in a similar way as clutch disc 441 of FIG. 4. That is, angular position sensor 950 is used as an angular position sensor from which an angle detector (such as angle detector 450) receives raw angle data or raw angle signal as key 800 rotates rotor 920.

FIG. 9C shows key 800 of FIG. 8 engaged with lock 900 of FIG. 9A. Electric terminals 810 of key 800 contact slip rings 940 of rotor 920 and slip rings 940 contact electric terminals 960 of stator 910. Electric terminals 960 are connected, by electric wires 970, to the electronic circuitry (not shown in FIG. 9C) of lock 900. Electrical continuity is maintained, by slip rings 940, between electric terminals 810 of key 800 and electric terminals 960 of stator 910, regardless of the angular orientation of key 800 inside lock 900.

FIGS. 10A, 10B, 10C, and 10D, show a key (shown at 1000) with a user angle indicator (shown at 1010) according to one example embodiment of the present disclosure. Referring to FIG. 10A, key 1000 includes a user angle indicator in the form of an angle dial 1010 and air bubble 1040. Angle dial 1010 includes on its periphery a ring-shaped transparent tube 1020 that is full of liquid 1030, except for a relatively small (e.g., 2-4 millimeter) gas (e.g., air) bubble 1040. Alternatively, gas bubble 1040 may be replaced with a liquid droplet that is lighter, or has a lower specific gravity, than liquid 1030, is not soluble in it and, preferably, has a different color than the color of liquid 1030 to render it visually conspicuous. In general, the function of liquid 1030 and air bubble 1040 may be performed by two, mutually insoluble, fluids, each fluid having a different specific gravity. One fluid serves as, or forms, a ”bath”, which means that it occupies most of the volume of the ring-shaped transparent tube, while the other fluid serves as a “marker”, which means that it serves as a reference point for numbers of code combinations; i.e., a number of a combination code is entered by aligning the number with the location of the marker body, or marker object. Depending on the involved specific gravities, the marker fluid may float in the fluid bath or sink in the fluid bath. The marker object may be solid. For example the marker object may be a hollow metallic ball that can float in a fluid bath, or it may be made heavy enough to cause it to sink in the fluid bath.

The two fluids may be two different liquids, in which case a liquid marker will always either float in a liquid bath or sink in it, depending on the involved specific gravities. Alternatively, one fluid may be liquid and the other gas, in which case a gas marker will float in a liquid bath. For example, one fluid may be water and the other oil, in which case an oil marker will float in a water bath, or one fluid may be oil and the other mercury, in which case a mercury marker will sink in an oil bath, and so on. Liquid 1030 and air bubble 1040 may also be replaced with a fluid and solid, where the fluid may be, for example, gas (e.g., air) or liquid, and the solid may be, for example, a metallic ball. As opposed to an air bubble that floats on liquid and provides the highest reference point, a metallic ball sinks in a fluid and provides the lowest reference point. Therefore, in general, any of the following marker-bath alternatives can be used with a ring-shaped tube: a liquid marker in a liquid bath, a gas marker in a liquid bath, a liquid marker in a gas bath, and a solid marker in a fluid bath.

Angle dial 1010 and ring-shaped tube 1020 are jointly rotatable CW and CCW by the key's operator rotating ring-shaped tube 1020. By way of example, angle dial 1010 has imprinted thereon eight dial numbers (i.e., 0, 4, 8, 12, 16, 20, 24, and 28) and ring-shaped tube 1020 has thirty two equidistantly spaced marks on periphery of angle dial 1010, each of which corresponds to one of the numbers ”0” through “31”.

Because of the lighter weight of the air bubble 1040 (or lighter liquid droplet), air bubble 1040 (or lighter liquid droplet) remains at the highest possible location within ring-shaped tube 1020 regardless of the angular orientation of key 100. Therefore, air bubble 1040 (or lighter liquid droplet) is used as a convenient fiducial indicia, or reference point, to which the key's operator aligns the required numbers of a combination code. For example, FIG. 10A shows angle dial 1010, and therefore key 1000, in a first angular position in which one of the 32 marks corresponding to the number “0” is aligned with the air bubble 1040, and FIG. 10B shows angle dial 1010, and therefore key 1000, in a second angular position in which one of the 32 marks corresponding to the number “12” is aligned with the air bubble 1040. In one embodiment the reference point to which the key's operator aligns the numbers of a combination code is associated with, served or implemented by, the fluid that has the lower specific gravity. In another embodiment the reference point to which the key's operator aligns the numbers of a combination code is associated with, served or implemented by, the fluid that has the higher specific gravity. Key 1000 may be said to be “self-contained” in the sense that the alignment means (i.e., liquid 1030 and air bubble 1040) is provided by the key, as opposed to including it in the lock system (not shown in FIGS. 10A through 10D).

As discussed above with respect to some embodiments, numbers of a combination code may be entered by rotating the key only CW or only CCW. However, according to another example embodiment of the present disclosure, the rotation direction of the key bears additional information as opposed to only entering the correct numbers in the correct order. That is, some transitions (i.e., from some number of a combination code to others) may involve rotating the key in the same direction (e.g., CW) while other transitions may involve rotating the key in the opposite direction (e.g., CCW). Considering an exemplary combination code 12-20-8-28 and an exemplary transitions pattern, the key operator may have to enter the first number “12” by first aligning the number “12” with air bubble 1040 by rotating the key arbitrarily (i.e., either CW or CCW), then rotate the key in the same direction as “12” to enter the number “20” by aligning the number “20” to air bubble 1040, then rotate the key in the opposite direction to enter number “8” by aligning the number “8” with air bubble 1040, and, finally, rotate the key in the same direction as number “8” to enter the last number “28”. Alternatively, instead of rotating the key to the first number in an arbitrary direction and deriving the “number-to-number” (i.e., within a combination code) transitions thereform, the number-to-number transitions, including the rotation direction to the first number, may be predetermined. Of course, other transition patterns may be used. Angle dial 1010 is pivotally coupled to the rest of key 100 (i.e., to the key's insert, shown in dashed line 1050 in FIG. 10A) via a gimbal bow 1070.

FIG. 10C shows the key 1000 of FIGS. 10A and 10B in a folded state in which the plane of angle dial 1010 and ring-shaped tube 1020 and the plane of the key's flat insert 1050 generally coincide. FIG. 10D shows the key 1000 of FIGS. 10A through 10C in unfolded (i.e., operational) state in which the angle dial 1010 and ring-shaped tube 1020 are 90 degrees displaced relative to the plane of the key's flat insert 1050. When in unfolded state, the key operator (not shown in FIGS. 10A through 10D) can rotate key 1000 while observing the actual key's angular orientation. When in folded state, key 100 can conveniently be inserted into, for example, a pans pocket.

FIGS. 11A, 11B, 11C, and 11D, show a key (shown at 1100) with a user angle indicator (shown at 1110) according to another example embodiment of the present disclosure. FIG. 11A shows a side view of key 1100 whose angle dial 1110, unlike angle dial 1010 of FIGS. 10A through 10D, is tubeless, which means that angle dial 1110 does not have a ring-shaped tube filled with liquid for accurately reading angular orientations of the involved key. FIG. 11B shows a front view of key 1100. FIGS. 111A and 11B show key 1100 in folded state.

FIG. 11C shows the key 1100 of FIGS. 11A and 11B in unfolded state, ready to be rotated in a lock (not shown in FIGS. 11C and 11D). Pointer 1180, which protrudes from lock panel 1190, replaces the air bubble in helping the key operator to precisely enter (“dial”) the combination numbers. FIG. 11D shows a front view of unfolded key 1100 engaged with the lock. Using a ring-shaped tube or a protruding pointer as replacement for the light source of FIG. 8 (for example) has several advantages. For example, there is no light coming out of the key, thus rendering combination codes harder to intercept visually by an observing third party and, in addition, electric power does not need to be supplied continuously while the key is rotated, and the key needs to engage electric terminals in the locking system only for a short time period (e.g., 0.5 to 3 seconds) that is sufficient for transferring its authentication data, after which there is no need to maintain electric continuity between the key and the locking system. Therefore, slip rings are eschewed if an angle dial such as angle dial 1010 of FIGS. 10A through 10D or angle dial 1110 of FIGS. 11A through 11D, is used instead of a light source. The numbers imprinted on the angle dial may be fluorescent and the liquid contained in the ring-shaped tube may be fluoroscopic so as to make the air bubble in the tube conspicuous in the dark. The angle dial will “click” into the folded state to avoid accidental unfolding thereof, or into the unfolded state to facilitate convenient rotation thereof by the key's operator.

In the description and claims of the present application, each of the verbs, “comprise”, “include” and “have”, and conjugates thereof, are used to indicate that the object or objects of the verb are not necessarily a complete listing of members, components, elements, or parts of the subject or subjects of the verb.

The articles “a” and “an” are used herein to refer to one or to more than one (i.e., to at least one) of the grammatical object of the article, depending on the context. By way of example, depending on the context, “an element” can mean one element or more than one element.

The term “including” is used herein to mean, and is used interchangeably with, the phrase “including but not limited to”.

The terms “or” and “and” are used herein to mean, and are used interchangeably with, the term “and/or,” unless context clearly indicates otherwise.

The term “such as” is used herein to mean, and is used interchangeably, with the phrase “such as but not limited to”.

Having thus described exemplary embodiments of the invention, it will be apparent to those skilled in the art that modifications of the disclosed embodiments will be within the scope of the invention. Alternative embodiments may, accordingly, include more modules, less modules, and/or functionally equivalent modules. For example, locking mechanism 410 and angle detector 450 of FIG. 4 may respectively be replaced by other locking mechanisms and angle detectors, and the key may generally be flat, rounded, or oval. A key may have slip rings or, alternatively, the key may rotate a mechanism that includes ring slips. The present disclosure is relevant, mutatis mutandis, to various types of locking mechanisms such as those which are used in banking security systems, in the car industry, and so on.

What is claimed is:

1. An electromechanical locking system comprising:
a) a locking mechanism that is switchable between a locked position and an unlocked position, the locking mechanism including a keyway for receiving a key, and a latch;
b) an angle detector adapted to detect a sequence of angular orientations of the key in the keyway and to issue a corresponding angle sequence data; and
c) a lock controller for controlling said latch in accordance with an authentication data received from the key and an angle sequence data issued by said angle detector.

2. The electromechanical locking system according to claim 1, wherein responsive to the lock controller ascertaining the validity of both the authentication data and angle sequence data, the lock controller enables operation of the latch.

3. The electromechanical locking system according to claim 1, wherein the angle sequence data indicates a pre-defined sequence of angular positions of the key.

4. The electromechanical locking system according to claim 3, wherein an angular position of the key is associated with a unique parameter.

5. The electromechanical locking system according to claim 4, wherein the unique parameter is a function of time.

6. The electromechanical locking system according to claim 2, wherein while the lock controller is in enabling state, the latch is operable electromechanically by the lock controller.

7. The electromechanical locking system according to claim 2, wherein while in enabling state, the latch is operable manually.

8. The electromechanical locking system according to claim 7, wherein the latch is operable by the key.

9. The electromechanical locking system according to claim 6, wherein the key is directly mechanically coupled to the latch.

10. The electromechanical locking system according to claim 6, wherein the key is coupled to the latch via a shaft.

11. The electromechanical locking system according to claim 1, wherein the angle detector detects the angular orientation of the key by using a shaft encoder.

12. The electromechanical locking system according to claim 1, wherein the angle detector detects the angular orientation of the key optically.

13. The electromechanical locking system according to claim 1, wherein the angle detector detects the angular orientation of the key mechanically.

14. The electromechanical lock system according to claim 1, wherein the key comprises:
a) a memory device for holding authentication data pertaining to one or more of the key, a user of the key, and the electromechanical locking system;
b) a communication interface for communicating the authentication data to the lock controller; and
c) a light source adapted to project a light beam in order to provide a visual indication of a current angular orientation of the key.

15. The electromechanical lock system according to claim 14, wherein the light source is a laser diode.

16. The electromechanical lock system according to claim 14, wherein the light source projects a light beam at an acute angle relative to a distal end of the key.

17. The electromechanical locking system according to claim 14, wherein the key further comprises a power and data communication connector to power the key and to facilitate bi-directional communication between the key and the lock controller.

18. The electromechanical lock system according to claim 14, wherein the communication interface conforms to the universal serial bus protocol.

19. A method of operating an electromechanical locking system having a locking mechanism that is switchable between a locked position and an unlocked position, an angle detector, and lock controller, the method comprising:
a) issuing, by the angle detector, angle sequence data associated with a sequence of angular orientations of a key mechanically coupled to the locking mechanism, the key containing authentication data; and
b) enabling, by the lock controller, operation of a latch of the locking mechanism if the authentication data is found by the lock controller to be valid, and the sequence of angular orientations matches a predetermined sequence of angular positions of the key.

20. The method according to claim 19, wherein an angular position in the predetermined sequence of angular positions is associated with a unique parameter.

21. The method according to claim 20, wherein the unique parameter is a function of time.

22. The method according to claim 19, wherein enabling operation of the latch includes enabling the latch to be operated electromechanically by the lock controller.

23. The method according to claim 19, wherein enabling operation of the latch includes enabling the latch to be operated manually.

24. The method according to claim 19, wherein detection, by the angle detector, of the angular orientation of the key is done optically.

25. The method according to claim 19, wherein detection, by the angle detector, of the angular orientation of the key is done mechanically.

26. The method according to claim 19, wherein data contained in the authentication data authorizes transitioning of the locking mechanism from the locking position to the unlocking position or from the unlocking position to the locking position.

27. The method according to claim 19, further comprising projecting, from the key, a light beam at an acute angle, relative to a distal end of the key, to visually indicate a current angular orientation of the key.

28. The method according to claim 19, wherein the authentication data is communicated from the key to the lock controller using the universal serial bus protocol.

29. A key for use in an electromechanical lock system, the key comprising:
a) a non-volatile memory device for holding authentication data pertaining to one or more of the key, a user of the key, and the electromechanical locking system;
b) a power and data communication connector on the periphery of the key;
c) a communication interface internally connected to the power and data communication connector and adapted to communicate therethrough the authentication data to a lock controller of the electromechanical lock system;
d) a user angle indicator to provide a visual indication of an angular orientation of the key when the key resides within a keyway of the electromechanical lock system.

30. The key according to claim 29, wherein the user angle indicator includes a light source.

31. The key according to claim 30, wherein the light source is a laser diode.

32. The key according to claim 30, wherein the light source projects a light beam at an acute angle relative to a distal end of the key.

33. The key according to claim 29, wherein the user angle indicator includes an angle dial on which numbers associated with combination codes are imprinted.

34. The key according to claim 33, wherein the user angle indicator further includes a ring-shaped transparent tube that is filled with two fluids, each fluid having a different specific gravity, and wherein a number of a combination code is entered by aligning the number with the location of one of the fluids.

35. The key according to claim 33, wherein the user angle indicator further includes a ring-shaped transparent tube that contains a marker object and a bath fluid, the marker object and the bath fluid having a different specific gravity, and wherein a number of a combination code is entered by aligning the number with the location of the marker object.

36. The key according to claim 35, wherein the marker object is selected from the group consisting of solid and fluid.

37. The key according to claim 29, wherein the power and data communication connector includes slip rings.

38. The key according to claim 29, wherein the power and data communication connector includes flat electric terminals.

39. The key according to claim 29, wherein the key shape is selected from the group consisting of flat and cylindrical.

40. The key according to claim 29, wherein the non-volatile memory device is a flash memory device.

41. The key according to claim 38, wherein the flash memory device is a write-once-read-many device.

42. The key according to claim 29, wherein the communication interface conforms to the universal serial bus protocol.
